(19) United States
(12) Patent Application Publication
(10) Pub. No.: US 2022/0205717 A1
(43) Pub. Date: Jun. 30, 2022

(54) RECOVERY OF NONCONDENSABLE GAS COMPONENTS FROM A GASEOUS MIXTURE

(71) Applicant: SAUDI ARABIAN OIL COMPANY, Dhahran (SA)

(72) Inventors: Feras HAMAD, Dhahran (SA); Sebastien DUVAL, Dhahran (SA); Milind VAIDYA, Dhahran (SA); Ghulam SHABBIR, Dhahran Hills (SA); Ahmad BAHAMDAN, Dammam (SA)

(73) Assignee: SAUDI ARABIAN OIL COMPANY, Dhahran (SA)

(21) Appl. No.: 17/139,949

(22) Filed: Dec. 31, 2020

(51) Int. Cl. F25J 3/06; F25J 3/02

(52) U.S. Cl. CPC F25J 3/069; F25J 3/061; F25J 3/0209; F25J 3/029; F25J 2230/30; F25J 2205/40; F25J 2205/60; F25J 2210/04; F25J 2210/60; F25J 2205/80

(57) ABSTRACT

A process for recovering a noncondensable gas from a gaseous mixture, the method comprising the steps of: supplying a gaseous mixture comprising a noncondensable component; supplying a sweep gas comprising a condensable component; introducing the gaseous mixture and the sweep gas to a swept membrane stage to obtain a retentate stream and a mixed permeate stream, the mixed permeate stream comprising at least a portion of the condensable component and at least a portion of the noncondensable component; introducing the mixed permeate stream to a vapor-liquid separator and subjecting the mixed permeate stream to thermodynamic conditions sufficient to condense most of the condensable component into a liquid, and obtain a raw noncondensable component stream, wherein the raw noncondensable component stream is enriched in the noncondensable component; and introducing the raw noncondensable component to a concentration unit to obtain a noncondensable component product stream enriched in the noncondensable component.

### TECHNICAL FIELD

The field of invention relates to membrane separation methods and apparatuses for obtaining a noncondensable component from a gaseous mixture; the methods and apparatuses are particularly relevant to membrane separations methods and apparatuses for obtaining helium from natural gas.

### BACKGROUND OF THE INVENTION

Helium is an industrially significant, nonrenewable resource that can be found in low concentrations in many natural gas deposits. It is typically extracted from natural gas using cryogenic or adsorptive processes. In a cryogenic process, the helium-containing gas is pressurized and cooled to condense the more condensable components, such as methane, so that less condensable components can be separated. In a typical helium recovery process, natural gas is sent to a nitrogen rejection unit, and is then treated using cryogenic fractionation to obtain a top product gas, crude helium, that contains helium and nitrogen (with trace contaminants such as hydrogen and xenon) and a bottom product, natural gas, that contains mostly methane. Crude helium can be processed further using cryogenic fractionation or pressure-swing adsorption to obtain additional grades of purity.

Membrane separation methods have also been suggested, however membrane selectivity of helium over nitrogen is generally not sufficiently large to allow the separation to be carried out in a single membrane stage. Membrane separation processes that have been proposed generally require multiple membrane stages, with recompression between stages. The costs of recompression can result in significant capital and operating costs.

### SUMMARY OF THE INVENTION

Membrane separation processes and systems are described herein that can reduce or eliminate recompression costs between stages, and in some instances produce energy. A process for recovering a noncondensable gas from a gaseous mixture is provided. The process includes the steps of: supplying a gaseous mixture comprising a noncondensable component; supplying a sweep gas comprising a condensable component; introducing the gaseous mixture and the sweep gas to a swept membrane stage to obtain a retentate stream and a mixed permeate stream, the mixed permeate stream comprising at least a portion of the condensable component and at least a portion of the noncondensable component; introducing the mixed permeate stream to a vapor-liquid separator and subjecting the mixed permeate stream to thermodynamic conditions sufficient to condense most of the condensable component into a liquid, and obtain a raw noncondensable component stream, wherein the raw noncondensable component stream is enriched in the noncondensable component; and introducing the raw noncondensable component to a concentration unit to obtain a noncondensable component product stream enriched in the noncondensable component.

According to at least one embodiment, the gaseous mixture can include natural gas and the noncondensable component can be helium. The condensable component can include a hydrocarbon selected from the group consisting of ethane, propane, butanes, pentanes, hexanes, and any combination of the same. According to at least one embodiment, the condensable component can include a C2+ hydrocarbon mixture. The vapor-liquid separator can be operated using a vapor-liquid separation process selected from the group consisting of knock-out separation, distillation, pressure-swing adsorption, absorption, and any combination of the same. According to at least one embodiment, the process can further include the step of evaporating the condensable component to produce an evaporated condensable component. The process can further include the step of using a turbine to generate power from the expansion of the evaporated condensable component.

A process for recovering a noncondensable gas from a gaseous mixture using a cascade configuration with a sweep stream in parallel is provided. The process includes the steps of: supplying a gaseous mixture comprising a noncondensable component; supplying a sweep gas comprising a condensable component; introducing the gaseous mixture and a first portion of the sweep gas to a first swept membrane stage to obtain a first retentate stream and a first mixed permeate stream, the first retentate, stream comprising at least a portion of the noncondensable component, the first mixed permeate stream comprising at least a portion of the condensable component and at least a portion of the noncondensable component; introducing the first retentate stream and a second portion of the sweep gas to a second swept membrane stage to obtain a second retentate stream and a second mixed permeate stream, the second mixed permeate stream comprising at least a portion of the condensable component and at least a portion of the noncondensable component; combining the first mixed permeate stream and the second mixed permeate stream to obtain a combined permeate stream comprising at least a portion of the condensable component and at least a portion of the noncondensable component; introducing the combined permeate stream to a vapor-liquid separator and subjecting the combined permeate stream to thermodynamic conditions sufficient to condense most of the condensable component in the combined permeate stream into a liquid, and obtain a raw noncondensable component stream, wherein the raw noncondensable component stream is enriched in the noncondensable component; and introducing the raw noncondensable component to a concentration unit to obtain a noncondensable component product stream enriched in the noncondensable component.

According to at least one embodiment, the gaseous mixture can include natural gas and the noncondensable component can be helium. The condensable component can include a hydrocarbon selected from the group consisting of ethane, propane, butanes, pentanes, hexanes, and any combination of the same. According to at least one embodiment, the condensable component can include a C2+ hydrocarbon mixture. The vapor-liquid separator can be operated using a vapor-liquid separation process selected from the group consisting of knock-out separation, distillation, pressure-swing adsorption, absorption, and any combination of the same. According to at least one embodiment, the process can further include the step of evaporating the condensable component to produce an evaporated condensable component. According to at least one embodiment, the process can further include the step of using a turbine to generate power from the expansion of the evaporated condensable component.

A process for recovering a noncondensable gas from a gaseous mixture using a cascade configuration with a sweep stream in series is provided. The process includes the steps of: supplying a gaseous mixture comprising a noncondensable component; supplying a sweep gas comprising a condensable component; introducing the gaseous mixture and the sweep gas to a first separation block, the separation block comprising a first swept membrane stage, a first vapor-liquid separator, and a first evaporator; introducing the gaseous mixture and the sweep gas to the first swept membrane stage to obtain a first retentate stream and a first mixed permeate stream, the first retentate stream comprising at least a portion of the noncondensable component, the first mixed permeate stream comprising at least a portion of the condensable component and at least a portion of the noncondensable component; introducing the first mixed permeate stream to the first vapor-liquid separator and subjecting the combined permeate stream to thermodynamic conditions sufficient to condense most of the condensable component in the combined permeate stream into a liquid, and obtain a first recovered condensable liquid stream and a first raw noncondensable component stream, wherein the first recovered condensable liquid stream comprises at least a portion of the condensable component, and wherein the raw noncondensable component stream is enriched in the noncondensable component; introducing the first condensable liquid stream to an evaporator to evaporate the condensable component and produce a subsequent sweep stream introducing the first retentate stream and the subsequent sweep stream to a subsequent separation block, the subsequent separation block comprising a subsequent swept membrane stage, a subsequent vapor-liquid separator, and a subsequent evaporator; introducing the first mixed permeate stream to the first vapor-liquid separator and subjecting the combined permeate stream to thermodynamic conditions sufficient to condense most of the condensable component in the first mixed permeate stream into a liquid, and obtain a first recovered condensable liquid stream and a first raw noncondensable component stream, wherein the first recovered condensable liquid stream comprises at least a portion of the condensable component, and wherein the first raw noncondensable component stream is enriched in the noncondensable component; introducing the first retentate stream and the subsequent sweep gas to the subsequent swept membrane stage to obtain a subsequent retentate stream and a subsequent mixed permeate stream, the subsequent retentate stream comprising at least a portion of the noncondensable component, the subsequent mixed permeate stream comprising at least a portion of the condensable component and at least a portion of the noncondensable component; introducing the subsequent mixed permeate stream to the subsequent vapor-liquid separator and subjecting the combined permeate stream to thermodynamic conditions sufficient to condense most of the condensable component in the subsequent mixed permeate stream into a liquid, and obtain a subsequent recovered condensable liquid stream and a subsequent raw noncondensable component stream, wherein the subsequent recovered condensable liquid stream comprises at least a portion of the condensable component, and wherein the subsequent raw noncondensable component stream is enriched in the noncondensable component; and introducing the first raw noncondensable component stream and the subsequent raw noncondensable component stream to a concentrating unit to obtain a noncondensable component product stream enriched in the noncondensable component.

According to at least one embodiment, the process further includes the step of bleeding a portion of the first mixed permeate stream and injecting makeup gas into the mixed permeate stream to control condensability of the mixed permeate stream, the makeup gas comprising the condensable component. According to at least one embodiment, the gaseous mixture includes natural gas and the noncondensable component can be helium. The condensable component can include a hydrocarbon selected from the group consisting of ethane, propane, butanes, pentanes, hexanes, and any combination of the same. According to at least one embodiment, the condensable component comprises a C2+ hydrocarbon mixture. The first vapor-liquid separator and the subsequent vapor-liquid separator can use a vapor-liquid separation process selected from the group consisting of knock-out separation, distillation, pressure-swing adsorption, absorption, and any combination of the same. According to at least one embodiment, the process can further include the step of using at least one turbine to generate power from the expansion of the evaporated condensable component. According to at least one embodiment, the process can generate more turbine power than it consumes for compression and pumping.

### BRIEF DESCRIPTION OF DRAWINGS

The embodiments of this disclosure will be understood by the following detailed description along with the accompanying drawings. The embodiments shown in the figures only illustrate several embodiments of the disclosure. The disclosure admits of other embodiments not shown in the figures, and is not limited to the contents of the illustrations.

FIG. 1 is an illustration of an embodiment of a process for separating a noncondensable gas from a gaseous mixture.

FIG. 2 is an illustration of an embodiment of a process for separating a noncondensable gas from a gaseous mixture using a cascading membrane stage configuration with sweep gas in parallel.

FIG. 3 is an illustration of an embodiment of a process for separating a noncondensable gas from a gaseous mixture using a cascading membrane stage configuration with sweep gas in series.

FIG. 4 is a plot comparison of helium recovery and membrane area requirements for a conventional helium recovery process and an embodiment of a process for separating a noncondensable gas from a gaseous mixture.

FIG. 5 is a plot comparison of helium recovery and power consumption for a conventional helium recovery process and an embodiment of a process for separating a noncondensable gas from a gaseous mixture.

### DETAILED DESCRIPTION

For certain embodiments, many details are provided for thorough understanding of the various components or steps. In other instances, well-known processes, devices, compositions, and systems are not described in particular detail so that the embodiments are not obscured by detail. Likewise, illustrations of the various embodiments can omit certain features or details so that various embodiments are not obscured.

The drawings provide an illustration of certain embodiments. Other embodiments can be used, and logical changes can be made without departing from the scope of this disclosure. The following detailed description and the embodiments it describes are not to be taken in a limiting sense. This disclosure is intended to disclose certain embodiments with the understanding that, many other undisclosed changes and modifications can fall within the spirit and scope of the disclosure. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

The description can use the phrases “in some embodiments,” “in various embodiments,” “in an embodiment,” or “in embodiments,” which can each refer to one or more of the same or different embodiments. Furthermore, the terms “comprising,” “including,” “having,” and the like, as used with respect to embodiments of the present disclosure, are synonymous.

As used in this disclosure, the terms “noncondensable gas” or “noncondensable component” refer to a gas, or component of a gaseous mixture, having thermodynamic properties such that the bulk of the gas or component does not condense into a liquid or solid phase at thermodynamic equilibrium under any given combination of thermodynamic conditions (i.e., temperature and pressure) of a relevant process for recovering the noncondensable gas. Similarly, the term “condensable gas” refers to a gas, or component of a gaseous mixture, having thermodynamic properties such that the hulk of the gas or component can be condensed into a liquid phase at thermodynamic equilibrium under a given combination of thermodynamic conditions of a relevant process for recovering a noncondensable gas.

This disclosure describes various embodiments related to processes and apparatuses for separating a noncondensable gas from a gaseous mixture. The processes can involve using a condensable sweep gas on the permeate side of a membrane to cause a partial pressure difference between the noncondensable gas on the retentate side of the membrane and permeate side; and using a thermodynamic-driven process to recover the noncondensable gas in a gas phase and the condensable component in a liquid phase.

An advantage of such a process is that the membrane separation can be carried out with a smaller pressure transmembrane pressure than is necessary for a comparable conventional process, As a result, less compression is needed to carry out subsequent membrane separation processes. Also, the condensable components of the combined permeate and sweep gas stream can be removed, knocked down, or absorbed to obtain the condensable component in a liquid phase and the noncondensable component in a gas phase; reducing the flow rate of the gas stream containing the noncondensable component. This reduced flow rate results in a reduction in energy and equipment size in subsequent processes.

### Feed Gas

The disclosed processes are particularly suitable for recovering noncondensable gases, such as helium and nitrogen, from natural gas, but can be adapted to separate a noncondensable gas component from any gaseous mixture that contains one. Whether a gas is noncondensable depends on thermodynamic conditions that exist in the relevant process. A gas, or component of a gaseous mixture, is noncondensable if it would remain a gas at equilibrium under any combination of thermodynamic conditions present in the process for recovering the noncondensable gas. Mixtures of gases that include helium can be particularly suitable because helium is noncondensable under a wide range of thermodynamic conditions; at standard pressure, helium condenses to a liquid phase at a temperature of only about 4 K (−269° C.) or less. Similarly, mixtures containing carbon dioxide (CO₂) can be a suitable noncondensable gas; carbon dioxide does not condense into a liquid phase at standard pressure. Mixtures of gases containing nitrogen gas (N₂) can also be suitable, since nitrogen gas condenses to a liquid phase at a temperature of about 77 K (−195.8° C.) at standard pressure and the process can readily be designed with conditions such that nitrogen does not condense into a liquid phase.

According to at least one embodiment, helium, nitrogen, or both helium and nitrogen, can be recovered from natural gas using a disclosed process, where natural gas is the feed gas and helium, or helium and nitrogen, is the noncondensable component. The composition of helium in natural gas can vary from a few parts per million by volume (ppmv) to about 10 volume percent (vol %). Nitrogen is generally also present in helium-containing natural gas. According to at least one embodiment, the volume percentage of nitrogen in the natural gas can be between 10 and 20 times the volume percentage of helium. The natural gas can be pretreated to remove dust, water, carbon dioxide, hydrogen sulfide (H₂S), and heavy hydrocarbons (i.e., C6+ hydrocarbons). A significant volume percentage of natural gas can include methane (CH₄) and other alkanes, such as ethane (C₂H₆). propane (C₃H₈) and butanes (C₄H₁₀). However, according to at least one embodiment, the process can be carried out using a feed gas having less than about 20 vol % methane and other alkanes, alternately less than about 10 vol %.

According to at least one embodiment, the process can be carried out using a feed gas in the absence of hydrocarbons. For instance, some natural gas samples have been determined to contain less than about 1 vol % methane. Another example can include natural gas after it has been processed in a nitrogen rejection unit. A nitrogen rejection unit removes nitrogen from a gas, typically using a cryogenic process. In most nitrogen rejection units, nitrogen-containing natural gas is cooled such that methane in the natural gas is condensed into a liquid and nitrogen (and helium when present) remains in a gas phase.

### Membrane Stage

A useful measure of the separating power of a membrane is its selectivity, which is the ratio of permeability of relevant gases for the membrane. Selectivity indicates the level to which the membrane is able to separate a given species from another. A selectivity of 1 indicates that the membrane will not separate the two species because both will diffuse equally through the membrane. The processes and apparatuses of this disclosure can use any membrane having selectivity for the noncondensable gas that is to be recovered from the feed gas. According to at least one embodiment, the membrane can be selected such that, it is selective for helium over methane. According to at least one embodiment, the membrane can have selectivity for helium over methane greater than about 10, alternately greater than about 25, alternately greater than about 50. According to at least one embodiment, the membrane can have selectivity for nitrogen gas over methane greater than about 5, alternately greater than about 10. According to at least one embodiment, the membrane can be selected from the following: polymeric membranes, ceramic membranes, zeolite membranes, or any combination of the same.

Another useful property of a membrane is its permeance, which indicates the ability of a relevant species to diffuse through the membrane. Permeance is expressed by the ratio of the permeability of the membrane divided by its thickness. Permeability is affected by the size of the permeating species. Smaller gas molecules generally diffuse more readily than larger gas molecules, resulting in greater permeability. The permeability of a membrane is described by the flux of the permeate divided by the transmembrane pressure. Helium gas permeance can range from as low as 1 GPU, up to more than 1,000 GPU. According to at least one embodiment, the membrane can have helium gas permeance of at least 50 gas permeation units (GPU), alternately at least 75 GPU, alternately at least 100 GPU. Nitrogen gas permeance can range from as low as 0.1 GPU, up to more than 100 GPU. According to at least one embodiment, the membrane can have nitrogen gas permeance of at least about 1 GPU.

Permeation of a gas component through a membrane can be driven by a difference in partial pressure of the gas component across the membrane, as shown in Equation 1.

$$\begin{matrix}{Q}_{i} = {p}_{i} {AP}_{F} ( {X}_{i} - \frac{{Y}_{i}}{{P}_{R}} ) & Eqn . 1 \\ {P}_{R} = \frac{{P}_{F}}{{P}_{P}} & Eqn . 2\end{matrix}$$

Where Qᵢ, pᵢ, Xᵢ, and Yᵢ are the permeation rate across the membrane, permeance factor, composition in the feed, and composition in the permeate of component i respectively; and factors A, P_{F}, P_{P}, and P_{R} are surface area, pressure on the retentate or feed side of the membrane, pressure on the permeate side, and pressure ratio of the pressure on the feed or retentate side of the membrane relative to the pressure on the permeate side respectively. Permeation of a gas component across a membrane increases as the difference in partial pressure of the gas component across the membrane increases, or as the membrane area increases. This can be done using various methods, such as increasing the total pressure of the feed gas on the retentate side of the membrane, applying a vacuum on the permeate side, increasing the total area of the membrane, or using a sweep gas on the permeate side to sweep away the permeate. When a sweep gas is used, the permeation rate can be determined using Equations 3-5.

$$\begin{matrix}{Q}_{i} = {p}_{i} {AP}_{F} ( {X}_{i} - \frac{{Y}_{i}^{*}}{{P}_{R}^{*}} ) & Eqn . 1 \\ {Y}_{i}^{*} = \frac{{Y}_{i}}{D} & Eqn . 4 \\ {P}_{R}^{*} = \frac{{P}_{F}}{{P}_{S}} & Eqn . 5\end{matrix}$$

Where D is the dilution factor affected by the sweep stream, and P_{R}* is the pressure ratio of the pressure on the feed or retentate side of the membrane relative to the pressure on the permeate side with the sweep stream. An advantage of using a sweep stream includes the ability to increase the driving force across the membrane without a large pressure ratio across the membrane (i.e., P_{R}* is less than P_{R}). When the solute to be recovered is a noncondensable gas, or component of a gaseous mixture, and a condensable gas is used as a sweep gas, the noncondensable component can be separated from the condensable sweep gas by being knocked down or absorbed to recover the sweep gas in a liquid phase and obtain the enriched noncondensable component in a gas phase. Such a process requires less energy and smaller equipment than a comparable conventional process.

### Sweep Gas

The sweep gas should have a relatively low partial pressure of the noncondensable component, relative to the feed gas; preferably, the sweep gas has an absence of the noncondensable component. According to at least one embodiment, the pressure ratio of the pressure on the feed or retentate side of the membrane relative to the pressure on the permeate side with the sweep stream, P_{R}*, is less than one.

Thermodynamic properties of the sweep gas are an important consideration when selecting a suitable sweep gas. A suitable sweep gas will have a major portion with thermodynamic properties such that it exists in a gas phase during membrane separation, but can later be condensed to a liquid phase for separating from the noncondensable component using a thermodynamic process such as knock-down separation, distillation, absorption, or pressure-swing adsorption. According to at least one embodiment, the sweep gas contains at least about 10 vol % condensable gas, alternately at least about 50 vol %, alternately at least about 80 vol %, alternately at least about 90 vol %, alternately at least about 95 vol %, alternately at least about 98 vol %, alternately at least about 99 vol %, alternately at least about 99.5 vol %, alternately at least about 99.9 vol %.

Because a portion of the sweep gas can be expected to transport across the membrane from the permeate side to the retentate side due to a difference in partial pressure in the reverse direction, consideration should be given to the desired characteristics of the retentate and the effect of the sweep gas on those characteristics. For example, a sweep gas having a much greater partial pressure of hydrogen sulfide than the feed gas may not be suitable if a very low concentration of the hydrogen sulfide is desirable or necessary in the retentate. Other considerations include availability of the sweep gas, compatibility with the noncondensable component to be recovered, and recoverability from the retentate stream. According to at least one embodiment, the portion of the sweep gas that permeates to the retentate side can be recovered in a downstream separation process to be recycled for use as a sweep stream.

According to at least one embodiment, the sweep gas can include a product of a natural gas condensate treatment process, or a natural gas liquids recovery process. The sweep gas can include a light hydrocarbon such as methane, ethane, propane, butanes, pentanes, or any combination of the same. According to at least one embodiment, the sweep gas can include a C2+ hydrocarbon mixture that includes mainly ethane, propane, butanes, and pentanes. The C2+ hydrocarbon mixture can also include heavier components, such as C6, C7, and heavier compounds in relatively minor concentrations. The C2+ hydrocarbon mixture can also include lighter components, such as methane, nitrogen, and helium, in minor or trace amounts. A sweep gas containing a major portion of ethane can be a particularly suitable sweep gas for recovering helium, nitrogen, or both from natural gas, because such streams are often available in facilities where natural gas is processed and can be readily condensed into a liquid using conventional thermodynamic processes and techniques. For similar reasons, steam can be a particularly suitable sweep gas for treatment at power plants or facilities where heat recovery boilers are used.

### Separation of Condensable and Noncondensable Gases

A mixed permeate stream having a condensable component and a noncondensable component can be separated using a thermodynamic vapor-liquid separation process such as knock-down separation, distillation, absorption, or adsorption. Such processes and techniques are well-known to one of ordinary skill in the art. A suitable separation process must be capable of condensing at least a portion of the condensable component into a liquid phase. Although it is possible to use cryogenic distillation, an advantage of the process is that less costly and more efficient thermodynamic vapor-liquid separation processes can be used. According to at least one embodiment, the vapor-liquid separation can be carried out without using cryogenic distillation. The noncondensable component can be recovered in a gas phase for use as a product, or for further purification such as by additional membrane separation, cryogenic distillation, pressure-swing adsorption, molecular centrifuge, or any combination of the same. In some instances, it may be necessary to compress the noncondensable component in the gas phase so that it can be used in other processes or further purified. According to at least one embodiment, the stream containing the noncondensable component after the mixed permeate is separated using a thermodynamic vapor-liquid separation process can be further separated in subsequent membrane stages without recompressing the recovered noncondensable gas. The condensable component recovered in a liquid phase can be used elsewhere in the plant, or vaporized and reused as a sweep gas. In some instances it may be necessary to expand the vaporized condensable component (i.e., decrease its pressure) before it can be reused as a sweep gas. An advantage of the latter configuration is that power can be generated by the expansion of the vaporized condensable component.

### Process Configurations

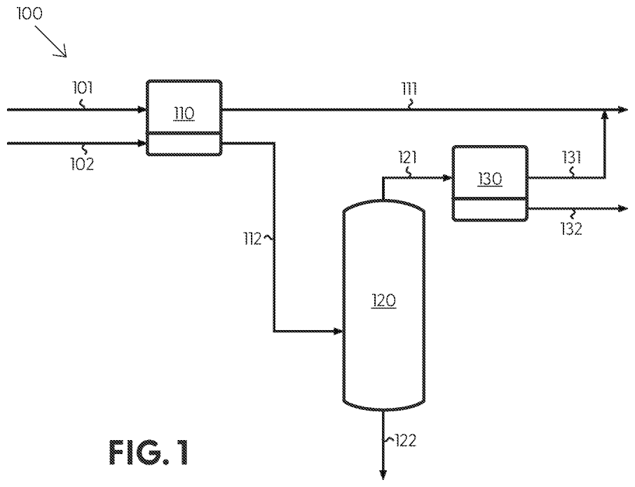

FIG. 1 shows an illustration of an embodiment of a process for separating a noncondensable gas from a gaseous mixture. In FIG. 1, a feed stream 101 having a gaseous mixture with a noncondensable component is fed to first membrane stage 110, which has a membrane with selectivity for the noncondensable component. A sweep stream 102 having a condensable component is fed to the permeate side of the first membrane stage 110 to enhance permeation of the noncondensable component through the membrane. According to at least one embodiment, the sweep stream 102 can be provided in a liquid phase, and then vaporized, or vaporized and expanded before being introduced to first membrane stage 110. The feed stream 101 is separated in the first membrane stage 110 using the sweep stream 102 to obtain a first retentate stream 111 and a mixed permeate stream 112; the mixed permeate stream 112 having the condensable component and at least a portion of the noncondensable component. The mixed permeate stream 112 is sent to a vapor-liquid separator 120 where the condensable component is condensed to a liquid to obtain a recovered condensable component stream 122 and a raw noncondensable component stream 121. The raw noncondensable component stream 121 can be sent to concentration unit 130, in this instance a membrane stage with a membrane having selectivity for the noncondensable component, to obtain a recovered noncondensable component stream 132 and a second retentate stream 131; the recovered noncondensable component stream 132 being further enriched in the noncondensable component.

### Cascading Membrane Stage Configurations

A greater percentage of the noncondensable component can be recovered using additional membrane separation stages in a cascading configuration. This disclosure describes two cascading membrane stage configurations that can be used to increase recovery: (1) cascade with parallel sweep, and (2) cascade with series sweep.

Cascade with Parallel Sweep

In a cascade with parallel sweep configuration, the sweep gas is distributed from the source to two or more membrane stages. The mixed permeate, including the sweep gas and the noncondensable component, from two or more membrane stages can be combined before being sent to a vapor-liquid separator to recover the sweep gas in a liquid phase and the noncondensable component in a gas phase. This configuration allows a common unit or units to be used for recovering the condensable gas from the sweep gas-containing permeate.

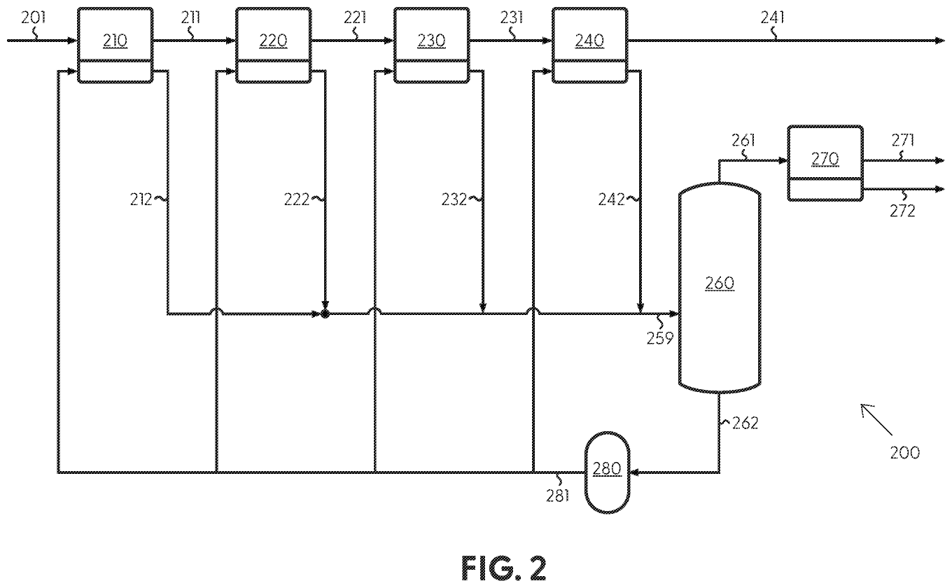

FIG. 2 shows an example of a cascade membrane stage configuration using parallel sweep. In FIG. 2, a feed stream 201 having a gaseous mixture that includes a noncondensable component, and a portion of parallel sweep stream 281 having a condensable component are introduced to first swept membrane stage 210. The first swept membrane stage 210 can be configured with a membrane having selectivity for the noncondensable component. The parallel sweep stream 281 is used to separate gaseous mixture of the feed stream 201 is separated in the first swept membrane stage 210 to obtain first retentate stream 211 and first mixed permeate stream 212. The first mixed permeate stream 212 includes at least a portion of the condensable component from parallel sweep stream 281 and at least a portion of the noncondensable component from feed stream 201. The first retentate stream 211 includes the rejected portion of the gaseous mixture including at least a portion of the noncondensable component.

The first retentate stream 211 is introduced to second swept membrane stage 220, which is configured similar to first swept membrane stage 210 with a membrane having selectivity for the noncondensable component. A portion of parallel sweep stream 281 is introduced to the permeate side of the second swept membrane stage 220 and is used to enhance permeation of the noncondensable component across the membrane. A second retentate stream 221 is obtained from the retentate side of the membrane; the second retentate stream 221 includes the rejected portion of the gaseous mixture including at least a portion of the noncondensable component. A second mixed permeate stream 222 having at least a portion of the condensable component from parallel sweep stream 281 and at least a portion of the noncondensable component from first retentate stream 211 leaves the permeate side of second swept membrane stage 220.

The second retentate stream 221 is introduced to third swept membrane stage 230, which is configured and operated similar to first swept membrane stage 210 and second swept membrane stage 220. Third swept membrane stage 230 produces third retentate stream 231 and third mixed permeate stream 232.

The third retentate stream 231 is introduced to fourth swept membrane stage 240, which is configured and operated similar to first swept membrane stage 210, second swept membrane stage 220, and third swept membrane stage 230. Fourth swept membrane stage 240 produces fourth retentate stream 241 and fourth mixed permeate stream 242.

In FIG. 2, the gaseous mixture from feed stream 201 is processed through four swept membrane stages. Here, the number of swept membrane stages is merely for illustration purposes. The actual number of swept membrane stages in a cascade configuration can vary, and is only limited by practical considerations such as cost of equipment and the flow rate of sweep gas in parallel sweep stream 281. A process having more swept membrane stages can increase recovery of the noncondensable component from the gaseous mixture of feed stream 201.

The first mixed permeate stream 212, second mixed permeate stream 222, third mixed permeate stream 232, and fourth mixed permeate stream 242 are combined in combined permeate stream 259, which includes the major portion of the condensable component from parallel sweep stream 281 and the cumulative noncondensable component separated from the gaseous mixture of feed stream 201. The combined permeate stream 259 is introduced to vapor-liquid separator 260, where it is subjected to thermodynamic conditions suitable to condense the condensable component in combined permeate stream 259 so that the remaining vapor is enriched in the noncondensable component. The condensable component leaves the vapor-liquid separator 260 in recovered condensable component stream 262 and raw noncondensable component stream 261. The recovered condensable component stream 262 is introduced to evaporator 280 where the liquid condensable component is vaporized for reuse as a sweep gas in parallel sweep stream 281. Makeup stream 263 can deliver makeup condensable component to the recovered condensable component stream 262 as needed.

The raw noncondensable component stream 261, which is enriched in the noncondensable component, is introduced to concentration unit 270, in this instance a membrane stage with a membrane having selectivity for the noncondensable component, to concentrate the raw noncondensable component stream 261, and produce reject stream 271 and product stream 272. The reject stream 271 can be depleted in the noncondensable component, and the product stream 272 can be enriched in the noncondensable component. According to at least one embodiment, the reject stream 271 can be combined with fourth retentate stream 241.

Equipment such as compressors, expansion turbines, and heat exchangers are not shown so as not to distract from other elements of the embodiment. One of ordinary skill in the art will appreciate that such equipment can be used to regulate temperature and pressure of various streams in the process.

An advantage of the cascade with parallel sweep configuration is that a significant difference in partial pressure can be maintained across membranes in swept membrane stages for recovery of the noncondensable component, while minimizing the transport of other components across the membranes. According to at least one embodiment, the sweep gas supplied to swept membrane stages is provided from a single source and has a uniform composition and partial pressure of the condensable component. According to at least one embodiment, the sweep gas can be expanded before being introduced to a membrane stage. According to at least one embodiment, the sweep gas can be expanded and power produced before the sweep stream is introduced to a membrane stage.

Cascade with Series Sweep

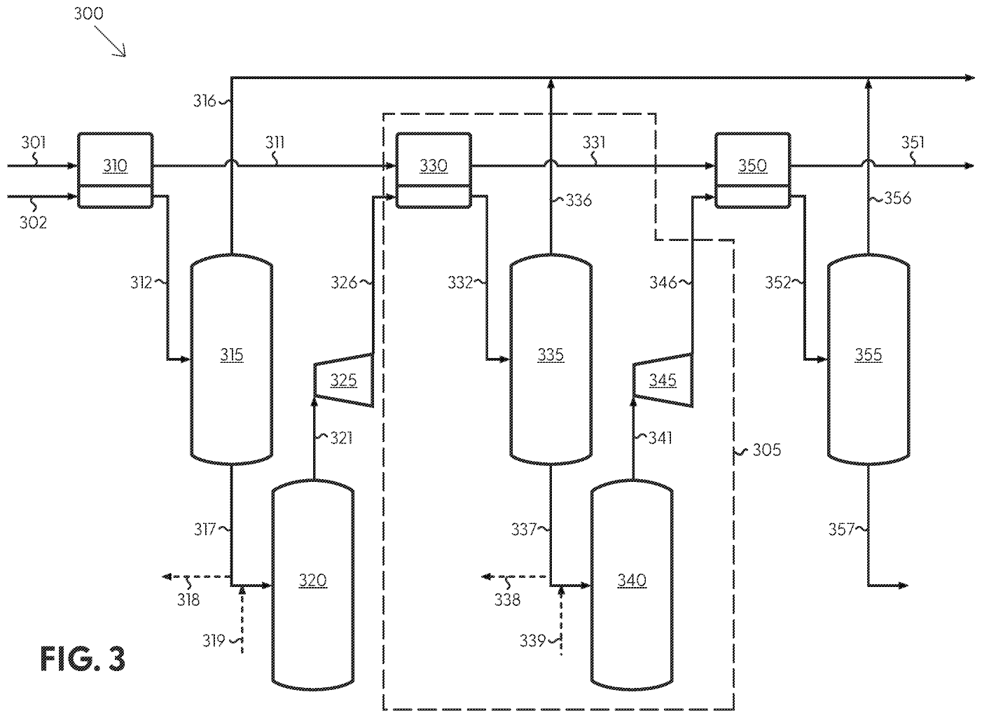

In a cascade with serial sweep configuration, the sweep gas is introduced to the permeate side of a swept membrane stage where it is used to enhance membrane separation and obtain a mixed permeate including the noncondensable component and the sweep gas. Then the mixed permeate is treated to separate the noncondensable component from the condensable component of the sweep gas by condensing the condensable component into a liquid phase. The liquid condensable sweep gas component can then be vaporized and introduced to a subsequent membrane stage. According to at least one embodiment, the vaporized condensable sweep gas component can be expanded before being introduced to a subsequent membrane stage. An example of a cascade with serial sweep configuration is shown in FIG. 3.

In FIG. 3, feed stream 301 and sweep stream 302 are introduced to first swept membrane stage 310 on the retentate side and permeate side respectively; the feed stream 301 having a gaseous mixture that includes a noncondensable component, and the sweep stream 302 having a condensable component. According to at least one embodiment, the sweep stream 302 can be provided in a liquid phase, and then vaporized, or vaporized and expanded before being introduced to first swept membrane stage 310. The gaseous mixture from feed stream 301 is separated in first swept membrane stage 310 using a membrane with selectivity for the noncondensable component, and using the sweep gas from sweep stream 302 on the permeate side of the membrane, to obtain first retentate stream 311 and first mixed permeate stream 312; the first retentate stream 311 having the rejected portion of the gaseous mixture, and the first mixed permeate stream 312 having a mixture that includes the condensable component and the permeated portion of the noncondensable component. The first mixed permeate stream 312 is introduced to first vapor-liquid separator 315 where it is separated under thermodynamic conditions sufficient to condense the condensable component into a liquid phase, leaving the noncondensable component to be enriched in the gas phase. The noncondensable component leaves the first vapor-liquid separator 315 in first raw noncondensable component stream 316, and the liquid condensable component leaves in first recovered condensable component stream 317. The condensable component in first recovered condensable component stream 317 can be bled using first bleed stream 318, and makeup condensable component can be added using first makeup stream 319. Because the composition of the sweep gas can change as it passes through multiple membrane stages, the first bleed stream 318 and first makeup stream 319 can be used to adjust the composition of the sweep gas to maintain a suitable concentration of condensable components. The first recovered condensable component can be sent to first evaporator 320 to produce first vaporized condensable component stream 321 containing the vaporized condensable component. If first evaporator 320 produces a sweep stream with a pressure greater than or equal to the pressure on the permeate side of the subsequent membrane stage, the first vaporized condensable component stream 321 can be expanded using a turbine. In FIG. 3, the first vaporized condensable component is expanded using first turbine 325, and the expanded first vaporized condensable component leaves the turbine in second sweep stream 326, which is sent to second swept membrane stage 330 to be reused as a sweep gas. The expansion of the first vaporized condensable component in first turbine 325 produces energy that can be recovered.

The second swept membrane stage 330 is configured similar to first swept membrane stage 310 with a membrane for separating a portion of the noncondensable component from the gaseous mixture in first retentate stream 311. Similarly, the first retentate stream 311 and second sweep stream 326 are fed to the second swept membrane stage 330, and processed to obtain second retentate stream 331 and second mixed permeate stream 332. The second retentate stream 331 is sent to third swept membrane stage 350, and the second mixed permeate stream 332 is sent to second vapor-liquid separator 335, which is operated similar to first vapor-liquid separator 315 to obtain second raw noncondensable component stream 336 and second recovered condensable component stream 337. The second recovered condensable component stream 337 can be bled or supplemented using second bleed stream 338 and second makeup stream 339 respectively, then introduced to second evaporator 340 to be vaporized similar to first evaporator 320, and then expanded in second turbine 345 similar to first turbine 325. Because the composition of the sweep gas can change as it passes through multiple membrane stages, the second bleed stream 338 and second makeup stream 339 can be used to adjust the composition of the sweep gas to maintain a suitable concentration of condensable components. The expanded and vaporized condensable component leaves second turbine 345 in third sweep stream 346 and is sent to third swept membrane stage 350.

Third swept membrane stage 350 is configured similar to first swept membrane stage 310 with a membrane for separating a portion of the noncondensable component from the gaseous mixture in second retentate stream 331. Similarly, the second retentate stream 331 and third sweep stream 346 are processed in third swept membrane stage 350 to obtain third retentate stream 351 and third mixed permeate stream 352. The third mixed permeate stream 352 is sent to third vapor-liquid separator 355, which is operated similar to first vapor-liquid separator 315 to obtain third raw noncondensable component stream 356 and third recovered condensable component stream 357. The third recovered condensable component stream 357 can be reused as a sweep stream, or recovered for use elsewhere in the plant or as a product. According to at least one embodiment, the third recovered condensable component stream 357 is purified using conventional purification techniques and methods before being recovered as a product or for use elsewhere in the plant.

The first-, second-, and third raw noncondensable component streams 316, 336, 356 can be combined and used as a product, or can be further purified using techniques and methods such as cryogenic distillation, pressure-swing adsorption, membrane separation, molecular centrifuge, etc.

A separation block 305 is identified in FIG. 3 with broken lines. The separation block 305 represents a single instance of a repeating process in the cascade configuration. FIG. 3 shows two such complete units for illustration purposes only. The actual number of repeating separation blocks 305 can vary and is only limited by practical considerations such as cost of equipment. Generally, a greater portion of the noncondensable component can be recovered from the gaseous mixture of feed stream 301 as the number of separation blocks increases. In a cascade with serial sweep configuration, the sweep gas is repeatedly introduced, used to enhance membrane separation, condensed, and vaporized for reuse. An advantage of this configuration is that it can be used with a limited supply of the condensable component.

### EXAMPLES

The following examples are included to demonstrate embodiments of the disclosure, and should be considered nonlimiting. The techniques, processes and apparatuses disclosed in the examples represent techniques, processes, and apparatuses discovered to function well in the practice of the disclosure, and can be considered to constitute modes for its practice. However, changes can be made to the embodiments disclosed in the examples without departing from the spirit and scope of the disclosure.

### Example 1

### Using Ethane as a Sweep Gas to Recover Helium from Natural Gas

A process using ethane as a sweep gas to recover helium from natural gas was simulated. The process took place in a natural gas plant with a capacity for processing 1,200 million standard cubic feet per day (MMCSFD) (about 34.00×10⁶ standard cubic meters per day (Sm³/d)). The natural gas was a gaseous mixture containing 0.05 mole percent (mol %) helium (He), 7.48 mol % nitrogen (N₂), 82.97 mol % methane (CH₄), and the balance C2+ hydrocarbons.

After acid gas removal, and before sending the natural gas to a deep Natural Gas Liquids (NGL) recovery plant to remove natural gas liquids and produce sales gas, the natural gas feed was fed to a membrane separation process to recover helium. The membrane separation process had a configuration similar to the process shown in FIG. 1, which is described previously. Liquid ethane, which was sourced from the NGL plant, was prepared for use as a sweep gas by vaporizing the liquid, and expanding and heating the resulting ethane gas. The ethane gas was used to sweep the permeate side of the membrane. The helium-lean retentate from the swept membrane stage was fed to the NGL plant. The mixed permeate, which contained the sweep gas and the permeate, was cooled to condense and separate natural gas liquids from the raw permeate. The condensed natural gas liquids were then vaporized, and the temperature and pressure regulated before being returned to the NGL plant. The raw permeate was enriched in helium, and contained the major portion of helium recovered from the membrane separation. The raw permeate was sent to a second membrane stage to further concentrate helium in the permeate stream. The retentate from this membrane separation contained mostly ethane, and was combined with the retentate from the first membrane stage to feed the NGL plant.

The first membrane stage had area of 24,079 m², and the second membrane stage had area of 16,855 m². The process was operated using 0.45 megawatts (MW) of compression power to compress the second retentate stream to be fed to the NGL plant, and 0.09 MW of pump power to pump the recovered ethane. Because the sweep stream produced excess pressure by its evaporation, a turbine was used to generate 0.22 MW of turbine power; resulting in net compression power of about 0.23 MW.

TABLE 1
Process stream composition and properties for example membrane separation
process using ethane as a sweep gas to recover helium from natural gas

| | | | | | | | |
|---|---|---|---|---|---|---|---|
| | | First | Mixed | Recovered | Raw | Second | Product |
| Feed | Sweep | retentate | permeate | ethane | helium | retentate | helium |
| stream | stream | stream | stream | stream | stream | stream | stream |

Stream Properties

| | | | | | | | | |
|---|---|---|---|---|---|---|---|---|
| Vapor fraction | 1.0 | 1.0 | 1.0 | 1.0 | 0.0 | 1.0 | 1.0 | 1.0 |
| Temperature (° C.) | 57.2 | 37.8 | 57.2 | 37.8 | 12.2 | 12.2 | 39.4 | 38.9 |
| Pressure^{a} (kPa) | 6,343 | 4,137 | 6,343 | 4,137 | 4,137 | 4,137 | 4,137 | 103.4 |
| Gas flow (10⁶ Sm³/d) | 34.00 | 1.42 | 33.86 | 1.55 | 0.67 | 0.88 | 0.83 | 0.06 |
| Liquid flow (Barrel/d) | — | — | — | — | 14,586 | — | — | — |

Stream Composition (mole percent)

| | | | | | | | | |
|---|---|---|---|---|---|---|---|---|
| Methane (CH₄) | 82.97 | 0.00 | 82.81 | 10.65 | 6.37 | 13.89 | 13.32 | 22.4 |
| Ethane (C₂H₆) | 7.00 | 100.00 | 7.19 | 87.80 | 92.95 | 83.89 | 84.76 | 70.9 |
| Propane (C₃H₈) | 1.50 | 0.00 | 1.50 | 0.05 | 0.07 | 0.03 | 0.03 | 0.0 |
| Butanes (C₄H₁₀) | 1.00 | 0.00 | 1.00 | 0.02 | 0.03 | 0.01 | 0.01 | 0.0 |
| Helium (He) | 0.05 | 0.00 | 0.05 | 0.08 | 0.02 | 0.12 | 0.01 | 1.8 |
| Nitrogen (N₂) | 7.48 | 0.00 | 7.44 | 1.41 | 0.56 | 2.05 | 1.87 | 4.8 |
| Carbon dioxide (CO₂) | 0.00 | 0.00 | 0.00 | 0.00 | 0.00 | 0.00 | 0.00 | 0.0 |
| Hydrogen sulfide (H₂S) | 0.00 | 0.00 | 0.00 | 0.00 | 0.00 | 0.00 | 0.00 | 0.0 |

^{a}Absolute pressure

TABLE 2
Membrane gas permeance factors and helium selectivity for
membranes used in example process that uses ethane as a sweep gas to
recover helium from natural gas

| Gas component | Gas permeance (GPU)^{a} | Selectivity for helium^{b} |
|---|---|---|
| Methane (CH₄) | 2.0 | 60 |
| Ethane (C₂H₆) | 1.0 | 170 |
| Propane (C₃H₈) | 0.5 | 240 |
| Butanes (C₄H₁₀) | 0.3 | 400 |
| Helium (He) | 120 | 1 |
| Nitrogen (N₂) | 3 | 40 |
| Carbon dioxide (CO₂) | 50 | 2.4 |
| Hydrogen sulfide (H₂S) | 50 | 2.4 |

^{a}GPU, Gas Permeance Units
^{b}Ratio of permeance of helium to relevant gas

In this example, helium was recovered and concentrated from about 0.05 mol % in the feed stream to about 1.8 mol % in the product helium stream. The helium recovered in in the product helium stream represented about 6 mol % of the helium from the feed stream. The product helium stream, which contained 1.8 mol % helium, can be processed further to increase purity to higher grades, e.g., 99.999 mol % helium, using such processes as cryogenic pressure-swing adsorption, membrane separation, molecular centrifuge, or any combination of the same.

### Example 2

### Using Multiple Swept Membrane Stages in a Cascade Membrane Separation Configuration with Parallel Sweep Streams to Recover Helium from Natural Gas

Simulations using a cascade membrane separation configuration with parallel sweep streams to recover helium from natural gas were carried out. Similar to Example 1, the simulations simulated processes in a natural gas plant with a capacity for processing 1,200 million standard cubic feet per day (MMSCFD) (about 34.00×10⁶ Sm³/d).

The feed stream to the simulated processes was assumed to have been treated for acid gas removal. The process was configured similar to the process shown in FIG. 2, which is described previously, only the simulations were carried out using 1, 6, 12, and 18 swept membrane stages. Similar to the process of FIG. 2, the swept membrane stages were arranged in series with respect to their feed streams (i.e., the reject or retentate from a previous membrane stage being fed to a subsequent membrane stage), and in parallel with respect to their sweep streams. Table 3 shows the results of the four simulations, and demonstrates the effect of using an increasing number of swept membrane stages. Liquid ethane, which was sourced from the NGL plant, was prepared for use as a sweep gas by vaporizing the liquid, and expanding and heating the resulting ethane gas similar to Example 1. The sweep stream was divided into equal streams sent to each swept membrane stage. The mixed permeate from each membrane stage, which contained the sweep gas and the permeate, was combined, cooled, and condensed to separate natural gas liquids from the raw permeate. The condensed natural gas liquid separated from the combined mixed permeate was then vaporized, and its temperature and pressure regulated before being returned to the NGL plant. The raw helium stream was enriched in helium, and contained the major portion of helium recovered from the membrane separation. The raw helium stream was heated and sent to a concentration unit which included a membrane stage to further concentrate helium and produce a product helium stream. The retentate from this membrane separation contained mostly ethane, and was combined with the feed to the NGL plant. The membrane stages of this process used membranes having the same properties as the membranes used in Example 1, and shown in Table 2.

TABLE 3
Summary of helium recovery and power consumption using increasing
number of swept membrane stages in cascade configuration with
parallel sweep streams

| | Number of swept membrane stages | | | |
|---|---|---|---|---|
| | 1 | 6 | 12 | 18 |
| Percent helium recovery | 5.98 | 31.0 | 49.1 | 60.6 |
| (%) | | | | |
| Helium purity (mol %) | 1.84 | 1.90 | 1.67 | 1.49 |
| Ethane flow rate | 1.42 | 8.50 | 17.00 | 25.50 |
| (10⁶ Sm³/d) | | | | |
| Swept membrane area (m²) | 24,079 | 144,473 | 288,946 | 433,419 |
| Concentrating unit | 16,855 | 101,133 | 202,262 | 303,393 |
| membrane area (m²) | | | | |
| Pump power (MW) | 0.085 | 0.508 | 1..04 | 1.60 |
| Compressor power (MW) | 0.45 | 2.73 | 5.33 | 7.82 |
| Turbine power (MW) | −0.22 | −1.29 | −2.61 | −3.93 |
| Net compressive power | 0.23 | 1.43 | 2.72 | 3.89 |
| consumed (MW) | | | | |

### Example 3

### Using a Cascade Membrane Separation Configuration with Serial Sweep Streams to Recover Helium from Natural Gas

A process using a cascade membrane separation configuration with serial sweep streams, and using ethane as a sweep gas to recover helium from natural gas was simulated. The process took place in a natural gas plant similar to the natural gas plant of Example 1 and Example 2, with a capacity for processing 1,200 million standard cubic feet per day (MMSCFD) (about 34.00×10⁶ standard cubic meters per day (Sm³/d)). The natural gas was a gaseous mixture containing 0.05 mole percent (mol %) helium (He), 7.48 mol nitrogen (N₂), 82.97 mol % methane (CH₄), and the balance C2+ hydrocarbons.

The process was carried out using a configuration similar to the process shown in FIG. 3, and described previously. In this example, the process used two swept membrane stages with the retentate from the first swept membrane stage being fed to the second swept membrane stage and the sweep stream being recovered after the first swept membrane stage to be reused in the second swept membrane stage. The ethane was sourced from the NGL plant, and was provided in a liquid phase. The liquid ethane was evaporated and the pressure and temperature regulated before being introduced to the first swept membrane stage. A turbine was used to generate power from excess pressure from vaporizing the ethane. In this example, distillation columns were used for vapor-liquid separation to process the mixed permeates, and condense the ethane to separate it from the raw helium. A distillation column provides better rectification and recovery of hydrocarbons in the liquid phase than a single flash stage. The composition and condensability of the recovered condensed liquid streams were controlled by bleeding a portion of the streams, and adding makeup liquid ethane. The recovered condensed liquid stream was then sent to evaporators to vaporize the condensed liquid. Turbines were used to generate power using excess pressure from the evaporation of the condensed liquid, and the temperature was regulated before being introduced to the second swept membrane stage. The raw helium streams recovered from the distillation columns were combined and sent to a concentration unit, in this instance a membrane stage. The retentate from the concentration unit was sent to the NGL plant, and the permeate was sent for further rectification. The membrane stages in this example had the same properties and characteristics as membrane stages used in previous examples. The first and second swept membrane stages each had membrane area of 15,795 m², and the concentration unit had membrane area of 1,263 m².

TABLE 4
Process stream composition and properties for first swept membrane stage of example
membrane separation process using cascade configuration with serial sweep streams

| | | | | | | | | |
|---|---|---|---|---|---|---|---|---|
| | | | First | First | | | First | First high |
| | First | First | Mixed | recovered | First raw | First | makeup | pressure |
| Feed | sweep | retentate | permeate | condensed | helium | Bleed | ethane | sweep |
| stream | stream | stream | stream | stream | stream | stream | stream | stream^{a} |

Stream Properties

| | | | | | | | | | |
|---|---|---|---|---|---|---|---|---|---|
| Vapor fraction | 1.0 | 1.0 | 1.0 | 1.0 | 0.0 | 1.0 | 0.0 | 0.0 | 1.0 |
| Temperature (° C.) | 57.2 | 37.8 | 57.2 | 37.8 | 7.7 | −66.2 | 22.8 | 26.7 | 57.2 |
| Pressure^{b} (kPa) | 6,343 | 4,137 | 6,343 | 4,137 | 4,137 | 4,137 | 5,516 | 5,516 | 5,516 |
| Molar flow (10⁶ Sm³/d) | 34.00 | 1.42 | 33.86 | 1.55 | 1.50 | 0.04 | 0.14 | 0.057 | 1.42 |

Stream Composition (mole percent)

| | | | | | | | | | |
|---|---|---|---|---|---|---|---|---|---|
| Methane (CH₄) | 82.97 | 0.00 | 82.81 | 10.65 | 9.26 | 56.34 | 9.26 | 13.32 | 8.89 |
| Ethane (C₂H₆) | 7.00 | 100.00 | 7.19 | 87.80 | 90.17 | 10.07 | 90.17 | 84.76 | 90.56 |
| Propane (C₃H₈) | 1.50 | 0.00 | 1.50 | 0.05 | 0.05 | 0.00 | 0.05 | 0.03 | 0.05 |
| Butanes (C₄H₁₀) | 1.00 | 0.00 | 1.00 | 0.02 | 0.02 | 0.00 | 0.02 | 0.01 | 0.02 |
| Helium (He) | 0.05 | 0.00 | 0.05 | 0.08 | 0.00 | 2.50 | 0.00 | 0.01 | 0.00 |
| Nitrogen (N₂) | 7.48 | 0.00 | 7.44 | 1.41 | 0.50 | 31.09 | 0.50 | 1.87 | 0.48 |
| Carbon dioxide (CO₂) | 0.00 | 0.00 | 0.00 | 0.00 | 0.00 | 0.00 | 0.00 | 0.00 | 0.00 |
| Hydrogen sulfide (H₂S) | 0.00 | 0.00 | 0.00 | 0.00 | 0.00 | 0.00 | 0.00 | 0.00 | 0.00 |

^{a}Vaporized, recovered ethane before being used to generate power in turbine
^{b}Absolute pressure

TABLE 5
Process stream composition and properties for second swept membrane stage of example
membrane separation process using cascade configuration with serial sweep streams

| | | | | | | | | |
|---|---|---|---|---|---|---|---|---|
| | | | | | | | | Second |
| | | | Second | Second | Second | | Second | high |
| First | Second | Second | Mixed | recovered | raw | Second | makeup | pressure |
| retentate | sweep | retentate | permeate | condensed | helium | Bleed | ethane | sweep |
| stream | stream | stream | stream | stream | stream | stream | stream | stream |

Stream Properties

| | | | | | | | | | |
|---|---|---|---|---|---|---|---|---|---|
| Vapor fraction | 1.0 | 1.0 | 1.0 | 1.0 | 0.0 | 1.0 | 0.0 | 0.0 | 1.0 |
| Temperature (° C.) | 57.2 | 38.9 | 57.2 | 38.9 | −8.2 | −70.4 | 8.4 | 26.7 | 39.4 |
| Pressure^{a} (kPa) | 6,343 | 4,137 | 6,343 | 4,137 | 4,137 | 4,137 | 5,516 | 5,516 | 4,137 |
| Molar flow (10⁶ Sm³/d) | 33.86 | 1.42 | 33.74 | 1.54 | 1.50 | 0.05 | 0.14 | 0.057 | 1.42 |

Stream Composition (mole percent)

| | | | | | | | | | |
|---|---|---|---|---|---|---|---|---|---|
| Methane (CH₄) | 82.81 | 8.89 | 82.67 | 18.11 | 16.85 | 60.76 | 16.85 | 0.00 | 16.17 |
| Ethane (C₂H₆) | 7.19 | 90.56 | 7.37 | 79.90 | 82.01 | 8.23 | 82.01 | 1.00 | 82.73 |
| Propane (C₃H₈) | 1.50 | 0.05 | 1.51 | 0.09 | 0.10 | 0.00 | 0.10 | 0.00 | 0.09 |
| Butanes (C₄H₁₀) | 1.00 | 0.02 | 1.01 | 0.04 | 0.04 | 0.00 | 0.04 | 0.00 | 0.04 |
| Helium (He) | 0.05 | 0.00 | 0.04 | 0.07 | 0.00 | 2.33 | 0.00 | 0.00 | 0.00 |
| Nitrogen (N₂) | 7.44 | 0.48 | 7.41 | 1.79 | 1.00 | 28.67 | 1.00 | 0.00 | 0.96 |
| Carbon dioxide (CO₂) | 0.00 | 0.00 | 0.00 | 0.00 | 0.00 | 0.00 | 0.00 | 0.00 | 0.00 |
| Hydrogen sulfide (H₂S) | 0.00 | 0.00 | 0.00 | 0.00 | 0.00 | 0.00 | 0.00 | 0.00 | 0.00 |

^{a}Absolute pressure

TABLE 6
Process stream composition and properties for streams entering and leaving
concentration unit of example membrane separation process using cascade
configuration with serial sweep streams

| | Combined | Concentration | |
|---|---|---|---|
| | concentration | unit retentate | Product helium |
| | unit feed stream | stream | stream |
| | Stream Properties | | |
| Vapor fraction | 1.0 | 1.0 | 1.0 |
| Temperature (° C.) | 40.6 | 82.2 | 39.5 |
| Press-urea (kPa) | 4,137 | 6,343 | 103.4 |
| Molar flow (10⁶ Sm³/d) | 0.09 | 0.08 | 0.01 |
| | Stream Composition (mole percent) | | |
| Methane (CH₄) | 58.51 | 60.43 | 43.64 |
| Ethane (C₂H₆) | 9.17 | 9.89 | 3.53 |
| Propane (C₃H₈) | 0.00 | 0.00 | 0.00 |
| Butanes (G₄H₁₀) | 0.00 | 0.00 | 0.00 |
| Helium (He) | 2.42 | 0.10 | 20.41 |
| Nitrogen (N₂) | 29.90 | 29.58 | 32.42 |
| Carbon dioxide (CO₂) | 0.00 | 0.00 | 0.01 |
| Hydrogen sulfide (H₂S) | 0.00 | 0.00 | 0.00 |

Three turbines were used in the process to generate power in the process. The turbines generated 0.21 MW, 0.27 MW, and 0.29 MW of power. The process used a single compressor to compress the retentate from the concentration unit to be fed to the NGL plant. The compressor used 0.06 MW of power. Overall, the net compression power of the process was −0.7 MW. The process used three pumps for pumping liquids. The pumps used 0.11 MW, 0.11 MW, and 0.09 MW of power. Overall the process achieved 12.2% recovery of the helium supplied to the process by the feed stream, and the final product helium stream had a concentration of 20.4 mol % helium. Greater helium recovery could be achieved using additional separation blocks. Table 7 shows the results of several simulations using cascade configurations with sweep streams in series, and with an increasing number of separation blocks.

TABLE 7
Summary of helium recovery and power consumption using increasing
number of swept membrane stages in cascade configuration with serial
sweep streams

| | Number of swept membrane stages | | | |
|---|---|---|---|---|
| | 2 | 4 | 6 | 12 |
| Percent helium recovery (%) | 12.2 | 24.4 | 36.0 | 56.0 |
| Helium purity (mol %) | 20.4 | 20.0 | 19.7 | 11.6 |
| Ethane flow^{a} (10⁶ Sm³/d) | 1.53 | 1.67 | 1.83 | 2.24 |
| Total bleed (10⁶ Sm³/d) | 0.28 | 0.57 | 0.85 | 1.70 |
| Total swept membrane area | 31,590 | 63,180 | 94,770 | 189,540 |
| (m²) | | | | |
| Total concentration unit | 1,263 | 2,527 | 3,790 | 7,578 |
| membrane area (m²) | | | | |
| Total pumping power (MW) | 0.22 | 0.41 | 0.58 | 1.02 |
| Compressor power (MW) | 0.06 | 0.13 | 0.19 | 0.52 |
| Total turbine power (MW) | −0.77 | −1.38 | −2.01 | −3.66 |
| Net compressive power (MW) | −0.70 | −1.25 | −1.82 | −3.08 |

^{a}Total ethane flow rate, including makeup. Each process is supplied about 1.42 × 10⁶ Sm3/d to sweep the first swept membrane stage, and the balance is makeup ethane.

As shown in Table 7, only 1.83×10⁶ Sm³/d (about 1.42×10⁶ Sm³/d supplied to the first swept membrane stage, and about 0.41×10⁶ Sm³/d supplied as makeup ethane) is needed to recover 36% of helium at 19.7 mol % purity.

A comparison of the cascade configurations using parallel and serial sweep arrangements shows that, although the arrangements achieve similar helium recovery, the serial sweep arrangement requires less fresh ethane from the NGL plant. A comparison of the serial sweep process using six separation blocks (Table 7) and the parallel sweep process using six membrane stages (Table 3) shows that helium recovery for both processes is about 30-36%, but that the flow of ethane to the two processes is about 1.83×10⁶ Sm³/d and 8.50×10⁶ Sm³/d respectively. Both configurations produced similar power due to gas expansion in the turbines, indicating that the total gas evaporated and expanded is similar (i.e., about 8.5×10⁶ Sm³/d). However, less compression power and membrane area is required for the serial sweep configuration. This difference can be attributed to using distillation to rectify the helium concentration in the raw helium stream. The distillation process results in a reduced flow of the raw helium stream, which allows for less compression and membrane area in subsequent concentration processes.

### Example 4

### Using a Parallel Sweep Cascade Configuration and a Hydrocarbon Mixture as a Sweep Gas to Recover Helium from Natural Gas

In this example, a condensable hydrocarbon mixture is used as a sweep stream in a parallel sweep cascade configuration to recover helium from natural gas. A simulation was carried out using natural gas that had already been treated to remove acid gases before being supplied to a NGL plant. The natural gas and NGL plant were similar to those used in the previous examples. Here, the C2+ hydrocarbon mixture included mostly ethane and heavier hydrocarbons with trace amounts of methane. The process used six swept membrane stages in a configuration similar to FIG. 2. Distillation was used for vapor-liquid separation, to segregate heavy components and rectify the raw helium stream with lighter components such as methane, nitrogen, and helium. The raw helium stream was concentrated in a concentration unit using a membrane stage with a membrane having selectivity for helium.

TABLE 8
Process stream composition and properties for example membrane separation process using a C2 + hydrocarbon
mixture as a sweep gas in a parallel sweep cascade configuration to recover helium from natural gas

| | | | | | | | | |
|---|---|---|---|---|---|---|---|---|
| | | | | | | | Recovered | |
| | | First | Mixed | Raw | Recovered | | condensable | Concentration |
| Feed | Sweep | retentate | permeate | helium | condensable | Bleed | stream with | unit permeate |
| stream | stream | stream | stream | stream | stream | stream | makeup | stream |

Stream Properties

| | | | | | | | | | |
|---|---|---|---|---|---|---|---|---|---|
| Vapor fraction | 1.0 | 1 .0 | 1.0 | 1.0 | 1.0 | 0.0 | 0.0 | 0.0 | 1.0 |
| Temperature (° C.) | 57.2 | 93.3 | 57.2 | 57.2 | −68.4 | −10.0 | 9.72 | 48.9 | 10 |
| Pressure^{a} (kPa) | 6,343 | 5,516 | 6,343 | 3,447 | 3,447 | 3,447 | 5,516 | 5,516 | 101.4 |
| Molar flow (10⁶ Sm³/d) | 34.00 | 8.50 | 33.41 | 9.08 | 0.42 | 8.66 | 1.94 | 1.78 | 0.04 |

Stream Composition (mole percent)

| | | | | | | | | | |
|---|---|---|---|---|---|---|---|---|---|
| Methane (CH₄) | 82.97 | 13.06 | 82.61 | 18.91 | 72.22 | 16.31 | 16.31 | 0.83 | 59.83 |
| Ethane (C₂H₆) | 7.00 | 58.43 | 7.40 | 53.63 | 8.13 | 55.84 | 55.84 | 68.21 | 3.48 |
| Propane (C₃H₈) | 1.50 | 13.42 | 1.56 | 12.44 | 0.15 | 13.03 | 13.03 | 14.90 | 0.03 |
| i-Butane (C₄H₁₀) | 1.00 | 9.09 | 1.03 | 8.45 | 0.02 | 8.86 | 8.86 | 9.94 | 0.00 |
| n-Butane (C₄H₁₀) | 0.00 | 4.27 | 0.01 | 3.96 | 0.00 | 4.16 | 4.16 | 4.69 | 0.00 |
| i-Pentane (C₅H₁₂) | 0.00 | 0.86 | 0.00 | 0.80 | 0.00 | 0.84 | 0.84 | 0.94 | 0.00 |
| n-Pentane (C₅H₁₂) | 0.00 | 0.46 | 0.00 | 0.43 | 0.00 | 0.45 | 0.45 | 0.50 | 0.00 |
| Helium (He) | 0.05 | 0.00 | 0.03 | 0.07 | 1.49 | 0.00 | 0.00 | 0.00 | 14.97 |
| Nitrogen (N₂) | 7.48 | 0.39 | 7.35 | 1.31 | 17.99 | 0.50 | 0.50 | 0.00 | 21.67 |
| Carbon dioxide (CO₂) | 0.00 | 0.00 | 0.00 | 0.00 | 0.00 | 0.00 | 0.00 | 0.00 | 0.01 |
| Hydrogen sulfide (H₂S) | 0.00 | 0.00 | 0.00 | 0.00 | 0.00 | 0.00 | 0.00 | 0.00 | 0.00 |

^{a}Absolute pressure

Overall helium recovery for this process was about 34.1%, with helium purity of about 14.97 mol %. The swept membrane stages each had membrane area of about 15,795 m² for a total membrane area of about 64,774 m². The concentration unit had membrane area of about 6.950 m². The process used about 0.36 MW to compress the concentration unit retentate before sending it to the NGL plant, and generated about 3.06 MW from the evaporation of the liquid hydrocarbons. Overall, the process generated 3.06 MW of net compressive power. The total amount of the C2+ hydrocarbon mixture required by the process, including makeup, was about 63 MMSCFD (1.78×10⁶ Sm³/d), while the total sweep flow is about 300 MMSCFD (8.5×10⁶ Sm³/d).

An advantage of using the C2+ hydrocarbon mixture as a sweep gas is the possible byproduct of power generation. A relatively low quality energy stream can be used to partially or completely evaporate the liquid hydrocarbons and produce pressurized hydrocarbon vapor. The temperature of the evaporated C2+ hydrocarbon mixture after it leaves the evaporator and before it is expanded to the sweep pressure is greater than the temperature of comparable streams in the previous examples, as shown in Table 9.

TABLE 9
Evaporator temperature and pressure used in Examples 1-4

| | Example | | | | |
|---|---|---|---|---|---|
| | 1 | 2 | 3^{a} | 3^{b} | 4 |
| Condensable | ethane | ethane | ethane | hydrocarbon | hydrocarbon |
| component | | | | mixture | mixture |
| Evaporation | 5,516 | 5,516 | 5,516 | 5,516 | 5,516 |
| pressure (kPa) | | | | | |
| Evaporation | 48.9 | 48.9 | 48.9 | 57.2 | 93.3 |
| temperature | | | | | |
| (° C.) | | | | | |
| Sweep | 4,137 | 4,137 | 4,137 | 4,137 | 3,447 |
| pressure (kPa) | | | | | |

^{a}Recovered from first separation block
^{b}Recovered from subsequent separation blocks

### Example 5

### Comparison of Disclosed Process with Conventional Two-Stage Membrane Process Configuration Using Inter-Stage Compression

In this Example, the results of Example 3 are compared with the results of a simulated two-stage membrane process using inter-stage compression without a sweep stream. The conventional process was simulated using two membrane stages having membranes with the same properties and characteristics as those used in the previous examples. In the conventional process, natural gas was fed to a first membrane to obtain retentate and permeate streams. The permeate from the first membrane was compressed in a compressor, cooled, and then sent to a second membrane. The retentate from the second membrane was recycled to the first membrane, and the permeate was evaluated for use as a helium product stream.

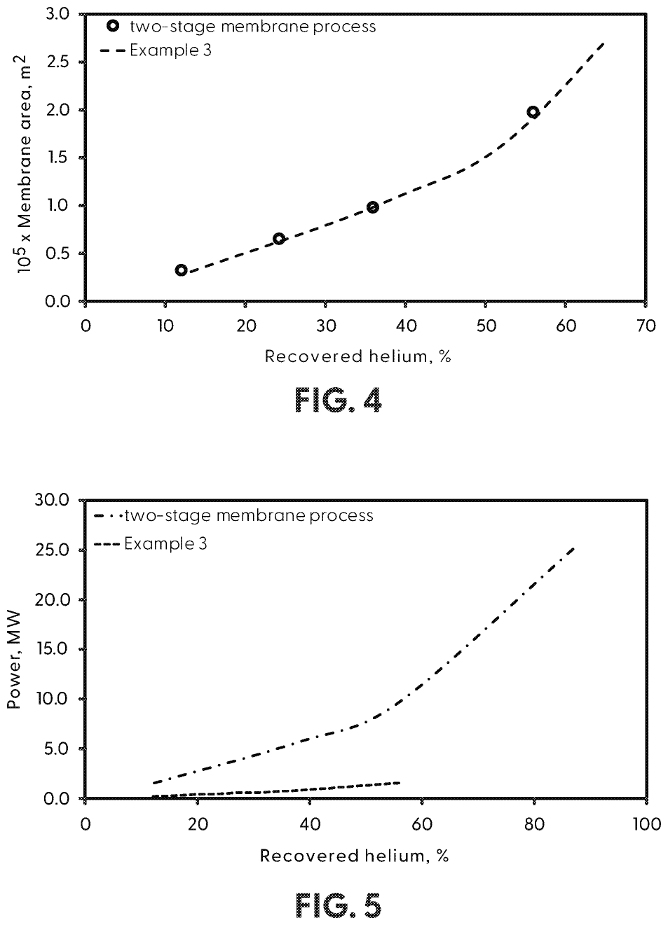

FIG. 4 shows a comparison oaf membrane area requirements for the conventional process and the process of Example 3. The comparison demonstrates that the two processes have similar membrane area requirements. FIG. 5 shows a comparison of compression requirements between the conventional process and the process disclosed in Example 3. As demonstrated in FIG. 5, the process described in Example 3 requires several times more power than the process described in Example 3. The relatively lower compression and pumping power required for the process of Example 3 suggests that the power needed to recover helium has shifted from compression energy to thermal energy, and thermal recovery and integration plays an important role in the process. Moreover, the results shown in FIG. 5 do not include the power generated by turbines after evaporating the liquid ethane. As shown in Table 7, the process of Example 3 produces more power due to turbine expansion than is needed for compression and pumping.

It is noted that the area requirements between the conventional process and the process of Example 3 are relatively similar. The conventional process has been evaluated using a pressure ratio of about 31 for each stage, which is created by a compressor. The process of Example 3, however, has a pressure ratio of 2 in the swept membrane stage and 40 in the concentration unit.

In this disclosure and the appended claims, unless otherwise indicated, all numbers expressing quantities, percentages or proportions, and other numerical values used in the specification and claims are to be understood as being modified in all instances by the term “about.” The term “about” applies to all numeric values, whether or not explicitly indicated. This term generally refers to a range of numbers that one of ordinary skill in the art would consider a reasonable amount of deviation to the recited numeric values.

Ordinal numbers (such as “first,” “second,” “third,” and so on), when used in this disclosure as an adjective before a term, merely identify a particular component, feature, step, or combination of these unless expressly otherwise provided. At times, ordinal numbers may be used to distinguish a particular feature from another feature that is described by the same term or similar term. Unless expressly otherwise provided, ordinal numbers do not indicate any relationship, order, quality, ranking, importance, or characteristic between features, components, steps, or combinations of these. Moreover, ordinal numbers do not define a numerical limit to the features, components, or steps identified with the ordinal numbers.

Ranges can be expressed in this disclosure as from about one particular value and to about another particular value. With these ranges, another embodiment is from the one particular value and/or to the other particular value, along with all combinations within the range. When the range of values is described or referenced in this disclosure, the interval encompasses each intervening value between the upper limit and the lower limit as well as the upper limit and the lower limit and includes smaller ranges of the interval subject to any specific exclusion provided.

Unless otherwise defined, all technical and scientific terms used in this specification and the appended claims have the same meanings as commonly understood by one of ordinary skill in the relevant art.

Where a method comprising two or more defined steps is recited or referenced in this disclosure or the appended claims, the defined steps can be carried out in any order or simultaneously except where the context excludes that possibility.

We claim:

1. A process for recovering a noncondensable gas from a gaseous mixture, the process comprising the steps of:
supplying a gaseous mixture comprising a noncondensable component;
supplying a sweep gas comprising a condensable component;
introducing the gaseous mixture and the sweep gas to a swept membrane stage to obtain a retentate stream and a mixed permeate stream, the mixed permeate stream comprising at least a portion of the condensable component and at least a portion of the noncondensable component;
introducing the mixed permeate stream to a vapor-liquid separator and subjecting the mixed permeate stream to thermodynamic conditions sufficient to condense most of the condensable component into a liquid, and obtain a raw noncondensable component stream, wherein the raw noncondensable component stream is enriched in the noncondensable component; and
introducing the raw noncondensable component to a concentration unit to obtain a noncondensable component product stream enriched in the noncondensable component.

2. The process of claim 1, wherein the gaseous mixture is natural gas and the noncondensable component is helium.

3. The process of claim 1, wherein the condensable component comprises a hydrocarbon selected from the group consisting of ethane, propane, butanes, pentanes, hexanes, and any combination of the same.

4. The process of claim 1, wherein the condensable component comprises a C2+ hydrocarbon mixture.

5. The process of claim 1, wherein the vapor-liquid separator is operated using a vapor-liquid separation process selected from the group consisting of knock-out separation, distillation, pressure-swing adsorption, absorption, and any combination of the same.

6. The process of claim 1, further comprising the step of evaporating the condensable component to produce an evaporated condensable component.

7. The process of claim 1, further comprising the step of using a turbine to generate power from the expansion of the evaporated condensable component.

8. A process for recovering a noncondensable gas from a gaseous mixture using a cascade configuration with a sweep stream in parallel, the process comprising the steps of:
supplying a gaseous mixture comprising a noncondensable component;
supplying a sweep gas comprising a condensable component;
introducing the gaseous mixture and a first portion of the sweep gas to a first swept membrane stage to obtain a first retentate stream and a first mixed permeate stream, the first retentate stream comprising at least a portion of the noncondensable component, the first mixed permeate stream comprising at least a portion of the condensable component and at least a portion of the noncondensable component;
introducing the first retentate stream and a second portion of the sweep gas to a second swept membrane stage to obtain a second retentate stream and a second mixed permeate stream, the second mixed permeate stream comprising at least a portion of the condensable component and at least a portion of the noncondensable component;
combining the first mixed permeate stream and the second mixed permeate stream to obtain a combined permeate stream comprising at least a portion of the condensable component and at least a portion of the noncondensable component;
introducing the combined permeate stream to a vapor-liquid separator and subjecting the combined permeate stream to thermodynamic conditions sufficient to condense most of the condensable component in the combined permeate stream into a liquid, and obtain a raw noncondensable component stream, wherein the raw noncondensable component stream is enriched in the noncondensable component; and
introducing the raw noncondensable component to a concentration unit to obtain a noncondensable component product stream enriched in the noncondensable component.

9. The process of claim 8, wherein the gaseous mixture is natural gas and the noncondensable component is helium.

10. The process of claim 8, wherein the condensable component comprises a hydrocarbon selected from the group consisting of ethane, propane, butanes, pentanes, hexanes, and any combination of the same.

11. The process of claim 8, wherein the condensable component comprises a C2+ hydrocarbon mixture.

12. The process of claim 8, wherein the vapor-liquid separator is operated using a vapor-liquid separation process selected from the group consisting of knock-out separation, distillation, pressure-swing adsorption, absorption, and any combination of the same.

13. The process of claim 8, further comprising the step of evaporating the condensable component to produce an evaporated condensable component.

14. The process of claim 13, further comprising the step of using a turbine to generate power from the expansion of the evaporated condensable component.

15. A process for recovering a noncondensable gas from a gaseous mixture using a cascade configuration with a sweep stream in series, the process comprising the steps of:
supplying a gaseous mixture comprising a noncondensable component;
supplying a sweep gas comprising a condensable component;
introducing the gaseous mixture and the sweep gas to a first separation block, the separation block comprising a first swept membrane stage, a first vapor-liquid separator, and a first evaporator;
introducing the gaseous mixture and the sweep gas to the first swept membrane stage to obtain a first retentate stream and a first mixed permeate stream, the first retentate stream comprising at least a portion of the noncondensable component, the first mixed permeate stream comprising at least a portion of the condensable component and at least a portion of the noncondensable component;
introducing the first mixed permeate stream to the first vapor-liquid separator and subjecting the combined permeate stream to thermodynamic conditions sufficient to condense most of the condensable component in the combined permeate stream into a liquid, and obtain a first recovered condensable liquid stream and a first raw noncondensable component stream, wherein the first recovered condensable liquid stream comprises at least a portion of the condensable component, and wherein the raw noncondensable component stream is enriched in the noncondensable component;
introducing the first condensable liquid stream to an evaporator to evaporate the condensable component and produce a subsequent sweep stream;
introducing the first retentate stream and the subsequent sweep stream to a subsequent separation block, the subsequent separation block comprising a subsequent swept membrane stage, a subsequent vapor-liquid separator, and a subsequent evaporator;
introducing the first mixed permeate stream to the first vapor-liquid separator and subjecting the combined permeate stream to thermodynamic conditions sufficient to condense most of the condensable component in the first mixed permeate stream into a liquid, and obtain a first recovered condensable liquid stream and a first raw noncondensable component stream, wherein the first recovered condensable liquid stream comprises at least a portion of the condensable component, and wherein the first raw noncondensable component stream is enriched in the noncondensable component;
introducing the first retentate stream and the subsequent sweep gas to the subsequent swept membrane stage to obtain a subsequent retentate stream and a subsequent mixed permeate stream, the subsequent retentate stream comprising at least a portion of the noncondensable component, the subsequent mixed permeate stream comprising at least a portion of the condensable component and at least a portion of the noncondensable component;
introducing the subsequent mixed permeate stream to the subsequent vapor-liquid separator and subjecting the combined permeate stream to thermodynamic conditions sufficient to condense most of the condensable component in the subsequent mixed permeate stream into a liquid, and obtain a subsequent recovered condensable liquid stream and a subsequent raw noncondensable component stream, wherein the subsequent recovered condensable liquid stream comprises at least a portion of the condensable component, and wherein the subsequent raw noncondensable component stream is enriched in the noncondensable component; and
introducing the first raw noncondensable component stream and the subsequent raw noncondensable component stream to a concentrating unit to obtain a noncondensable component product stream enriched in the noncondensable component.

16. The process of claim 15, further comprising the step of bleeding a portion of the first mixed permeate stream and injecting makeup gas into the mixed permeate stream to control condensability of the mixed permeate stream, the makeup gas comprising the condensable component.

17. The process of claim 15, wherein the gaseous mixture is natural gas and the noncondensable component is helium.

18. The process of claim 15, wherein the condensable component comprises a hydrocarbon selected from the group consisting of ethane, propane, butanes, pentanes, hexanes, and any combination of the same.

19. The process of claim 15, wherein the co e component comprises a C2+ hydrocarbon mixture.

20. The process of claim 15, wherein the first vapor-liquid separator and the subsequent vapor-liquid separator are operated using a vapor-liquid separation process selected from the group consisting of knock-out separation, distillation, pressure-swing adsorption, absorption, and any combination of the same.

21. The process of claim 5, further comprising the step of using an at east one turbine to generate power from the expansion of the evaporated condensable component.

22. The process of claim 21, wherein the process generates greater turbine power than it consumes for compression and pumping.
